(19) United States
(12) Patent Application Publication
(10) Pub. No.: US 2026/0312214 A1
(43) Pub. Date: Oct. 8, 2026

(54) BATTERY PACK COMPRISING A POLYSILOXANE COMPOSITE AND METHODS FOR PRODUCING THE SAME

(71) Applicants: DOW SILICONES CORPORATION, Midland, MI (US); DOW GLOBAL TECHNOLOGIES LLC, Midland, MI (US)

(72) Inventors: Xuesi YAO, Shanghai (CN); Xiangyang TAI, Shanghai (CN); Minbiao HU, Shanghai (CN); Yi GUO, Shanghai (CN); Cheng LIU, Shanghai (CN); Xinyan BAO, Shanghai (CN)

(21) Appl. No.: 19/484,222

(22) PCT Filed: May 15, 2023
(86) PCT No.: PCT/CN2023/094296

§ 371 Date: Nov. 13, 2025

(51) Int. Cl. H01M 50/293; H01M 10/658

(52) U.S. Cl. CPC H01M 50/293; H01M 10/658

(57) ABSTRACT

Provided is a battery pack comprising a polysiloxane composite and a method for producing the same. The battery pack comprises a polysiloxane composite, wherein the polysiloxane composite partially or fully fills a gap between two adjacent battery cells and has a mean cell size≤100 μm, which is much smaller than the silicone foam materials/pad made from similar silicone foam composition except using chemical foaming agents. The polysiloxane composite has compressibility which is tunable in a large range, compared with common silicone syntactic foam which is not as compressible.

### TECHNOLOGICAL FIELD OF THE PRESENT INVENTION

The present disclosure relates to a battery pack comprising a polysiloxane composite and a method for producing the same.

### BACKGROUND ART

As an agreed strategy to control carbon dioxide emission and to suppress global warming from green-house gas effect, electric vehicle (EV) powered by lithium-ion secondary battery (LiB) has started to surge in main geographies on the globe. Aiming at longer mileage per charge, EV battery manufactures are continuously increasing energy density in battery cathode and anode material and producing individual cells with larger and larger capacity. Consequently, the amount of heat generation during thermal runaway of one individual cell keeps increasing. To ensure passengers' safe evacuation, thermal insulation sheet material should be positioned between adjacent cells to delay heat transfer, so as to provide enough protection for the good cell next to the one in thermal runaway.

Typical thermal insulation sheet adopted by the industry is aerogel sheet with aerogel powders compacted in a fabric mat. Aerogel powders may ensure thermal insulation performance, and the fabric mat holds the powders together into the shape of a sheet. However, because of its intrinsic low density and poor Van der Waal's force between particles, aerogel powders on sheet surface can easily diffuse into atmosphere during handling, which causes pollution to working environment. How to develop fire protection sheet with good thermal insulation performance and clean working environment for battery assembly process is a strong demand in EV battery industry. Silicone rubber foam was expected to be reasonable alternative since the rubber itself can be ceramified at high enough temperature, therefore can still stand between the cell in thermal runaway and the good cell next to it. However, intrinsic silicone rubber foam does not have high enough thermal insulation performance after ceramification. The thermal insulation performance is evaluated by hot plate test, which is to mimic the scenario of thermal runaway. With certain hot plate temperature (e.g., 600° C.), back temperature of the silicone foam pad with certain thickness should be lower enough after certain heating time. It is to ensure the next cell will not be heated up to that temperature in the evacuation time. How to develop a novel battery pack to provide better thermal insulation performance is still a big challenge.

Patent Document 1 disclosed a secondary battery pack comprising 1) at least one battery module casing in which is disposed a plurality of battery cells which are electrically connected to one another; 2) a silicone rubber syntactic foam comprising a silicone rubber binder and hollow glass beads. The silicone rubber syntactic foam fills partially or fully open space of said battery module casing and/or covering partially or totally said battery cells and/or covering partially or totally said module casing, and optionally a lid covering the battery module casing. The silicone rubber syntactic foam is obtained by curing an addition curing type organopolysiloxane composition X, and wherein the addition curing type organopolysiloxane composition X comprises: a) at least one organopolysiloxane A having at least two alkenyl groups bonded to silicon per molecule, said alkenyl groups each containing from 2 to 14 carbon atoms, b) at least one silicon compound B having at least two hydrogen atoms bonded to silicon per molecule, c) hollow glass beads D, and d) a hydrosilylation catalyst C. However, the silicone rubber syntactic foam is not much compressible because of the hard wall of hollow glass beads.

Patent Document 2 disclosed a battery module comprising a plurality of battery cells, and one or more insulation barriers comprising at least one insulation layer, a support member surrounding at least a portion of insulation layer and an encapsulation layer at least partially surrounding the insulation layer, wherein the encapsulation layer contacts at least a portion of the support member. The insulation layer has thermal conductivity less than about 0.05 W/m·K at 25° C., and leas than 0.06 W/m·K at 600° C. The insulation layer may further comprise an aerogel. However, such multi-layer lamination structure may increase process complexity.

Patent Document 3 disclosed a thermal insulation/protection barrier operatively adapted for being disposed between adjacent battery cells of a battery pack or module, with the thermal insulation/protection barrier comprising a cured silicone rubber non-syntactic foam layer having at least one major surface, and at least one optional solid film, wherein the solid film is disposed so as to cover the at least one major surface of the silicone rubber foam layer, and the silicone rubber foam layer comprises a plurality of firming particles disposed within the silicone rubber foam layer in an amount sufficient to impart additional firmness to the silicone rubber foam layer so that it takes a greater compressive force to compress the foam layer to a desired compression value, compared to the same silicone rubber foam layer without the firming particles. Such thermal insulation/protection barrier requires firming particles to be disposed and positioned in silicone foam uniformly, that increases process complexity. Furthermore, adding firming particles can provide higher resistance to compression, but cannot surely increase thermal insualtion performance.

### Prior Art Documents

Patent Document 1: US Patent Publication No. U.S. Pat. No. 10,501,597B2
Patent Document 2: International Patent Publication No. WO2023279090A
Patent Document 3: International Patent Publication No. WO2023037270A

### SUMMARY OF THE INVENTION

### Problem to be Solved by the Invention

The problem to be solved by the invention is how to delay or prevent the propogation of thermal runaway in EV battery pack by increasing thermal insulation performance of the protection material positioned between cells, meanwhile maintaining good mechanical performance.

Further, it is other objective of the present invention to provide a process of producing such polysiloxane composite.

### Means for Solving the Problem

As a result of persistent investigation, the present inventors discovered a novel battery pack comprising a cured polysiloxane composite, which has greatly reduced thermal conductivity at high temperature of e.g., 600° C. and good mechanical performance.

One aspect of the present invention is a battery pack comprising a polysiloxane composite, wherein the polysiloxane composite partially or fully fills a gap between two adjacent battery cells, and has a mean cell size≤100 μm.

In some embodiments, the polysiloxane composite has a close cell percentage of ≥50%.

In some embodiments, the polysiloxane composite is obtained by curing a curable silicone-based composition comprising:
(A) at least one organopolysiloxane having at least two alkenyl groups bonded to silicon per molecule;
(B) at least one organopolysiloxane having at least two hydrogen atoms bonded to silicon per molecule;
(C) a hydrosilylation catalyst;
(D) at least one flame retardant filler; and
(E) water.

In some embodiments, component (B) is in an amount of 0.5~20 parts by weight, and/or component (D) is in an amount of 2-250 parts by weightbased on 100 parts by weight of component (A).

In some embodiments, component (E) is in an amount of 5~1000 parts by weight, based on 100 parts by weight of component (A).

In some embodiments, the curable silicone-based composition further comprises:
F) at least one thickener in an amount of 0.2~5 parts by weight, based on 100 parts by weight of component (E).

In some embodiments, the curable silicone-based composition further comprises:
(G) at least one emulsifier;
(H) at least one hydrosilylation catalyst inhibitor; and/or
(I) at least one opacifier.

In some embodiments, said thickener (F) is selected from the group consisting of nanoclay, cellulose, polyacrylate and mixtures thereof.

In some embodiments, said emulsifier (G) is selected from the group consisting of polysiloxane polyether, alkyl-poly(ethylene oxide) and mixtures thereof.

In some embodiments, said opacifier (I) is selected from the group consisting of carbon black, Fe₃O₄ and mixtures thereof.

A second aspect of the present invention is a process for producing the cured polysiloxane composite for battery pack, which comprises:
Step (I): providing a mixture comprising components (A), (B), (C) and (D);
Step (II): applying component (E) into the mixture under a mixing and shearing condition, so as to provide a water-in-oil emulsion comprising water droplets with average droplet size≤100 μm; and
Step (III): heating the water-in-oil emulsion to cure the polysiloxane matrix and form cured wet composite; and
Step (IV): assembling the cured composite between cells in battery pack.

In some embodiments, the process further comprises:
Step (I′): applying component (F) into component (E) under a mixing and shearing condition, so as to provide a thickened component (E) before Steps (I) and/or (II).

In some embodiments, Step (II) further comprises: applying components (G), (H) and/or (I) into the mixture under a mixing and shearing condition.

In some embodiments, the method further comprises:
Step (V): partially or fully removing water from wet polysiloxane composite formed in Step (III).

### Effect of the Invention

The present invention is able to provide a battery pack comprising a polysiloxane composite partially or fully fills a gap between two adjacent battery cells with an mean cell size≤100 μm, which is much smaller than the silicone foam materials/pad made from similar silicone foam composition except using chemical foaming agents and/or physical foaming agents. Further, the polysiloxane composite has good mechanical performance, like compressibility tunable in large range, compared with common silicone syntactic foam which is not much compressible. The battery pack of the present invention can exhibit good thermal insulation performance, which is not necessarily designed into multi-layer lamination structure.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram of an apparatus for testing thermal insulation performance of the silicone foam material according to the present disclosure.

FIG. 2 is SEM image of Comparative Example 1 according to the present invention.

FIG. 3 is SEM image of Comparative Example 2 according to the present invention.

FIG. 4 is SEM image of Inventive Example 1 according to the present invention.

FIG. 5 is SEM image of Inventive Example 2 according to the present invention.

FIG. 6 is SEM image of Inventive Example 3 according to the present invention.

FIG. 7 is SEM image of Inventive Example 4 according to the present invention.

FIG. 8 is SEM image of Inventive Example 5 according to the present invention.

FIG. 9 is SEM image of Inventive Example 6 according to the present invention

### DESCRIPTION OF THE PREFERRED EMBODIMENTS

Unless defined otherwise, all technical and scientific terms used herein have the same meaning as commonly understood by one of ordinary skill in the art to which the invention belongs. As disclosed herein, “and/or” means “and, or as an alternative” or “additionally or alternatively”. All ranges include endpoints unless otherwise indicated.

As used herein, the term “thickness” refers to an average of at least three measurements of a dried sheet (e.g., a sheet having a thickness of 0.2-10.0 mm) as measured using an Ames Gage, Model 13C-B2600 (Ames Corporation Waltham Mass).

As used herein, the term “polymer” or “polymeric” refers, in the alternative, to a polymer made from one or more different monomers, such as a copolymer, a terpolymer, a tetrapolymer, a pentapolymer etc., and may be any of a random, block, graft, sequential or gradient polymer.

In the present invention, the singular form of the articles “a,” “an,” and “the” includes plural references unless indicated otherwise. In the present invention, the terms “comprise”, “comprising”, “contain”, “containing”, “include”, “including” and their variants are open claim language, i.e., are permissive of additional elements.

In accordance with the present invention, the battery pack can comprise a polysiloxane composite which partially or fully fills a gap between two adjacent battery cells and has an mean cell size of ≤100 μm, ≤80 μm, ≤50 μm, ≤30 μm, ≤10 μm or ≤5 μm. In alternative embodiments of the present application, the mean cell size of the polysiloxane composite is greater than or equal to 100 nm, 300 nm, 500 nm, 800 nm or 1 μm.

In preferred embodiments, the polysiloxane composite has a close cell percentage of 50%, 60%, 7% 80%90%99%.

In some embodiments of the present invention, the polysiloxane composite can be obtained by curing a curable silicone-based composition, e.g., via emulsion curing process, comprising, substantially consisting of, or consisting of: (A) at least one organopolysiloxane having at least two alkenyl groups bonded to silicon per molecule; (B) at least one organopolysiloxane having at least two hydrogen atoms bonded to silicon per molecule; (C) a hydrosilylation catalyst; (D) at least one flame retardant filler; (E) water; (F) optionally, at least one thickener; (G) optionally, at least one emulsifier; (H) optionally, at least one hydrosilylation catalyst inhibitor; and/or (I) optionally, at least one opacifier.

### Component (A)

In the present invention, component (A) is well-known in the art; and examples thereof comprises alkenyl endblocked polyorganosiloxanes (i.e., vinyl-terminated PDMS) of the formula:

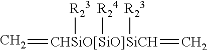

where R³ and R⁴ are selected from the group consisting of alkyl groups having from 1 to 6 carbon atoms per group, phenyl groups, and alkenyl groups with at least 50 percent of R⁴ being methyl group. Preferably, the viscosity of component (A) is from 100 cst to 200000 cst, from 1000 cst to 100000 cst, from 5000 cst to 50000 cst, from 8000 cst to 16000 cst, from 8000 cst to 14000 cst, from 8000 cst to 12000 cst or from 8000 cst to 10000 cst at 25° C.

In some embodiments of the present disclosure, the alkenyl groups contained in component (A) may comprise from 2 to 14 carbon atoms, 4 to 12 carbon atoms or 6 to 10 carbon atoms; preferably, the alkenyl groups are chosen from the group consisting of vinyl, allyl, hexenyl, decenyl and tetradecenyl, and most preferbly the alkenyl groups are vinyl groups.

With particular preference, component (A) may be incorporated into the curable silicone-based composition in an amount of from 20% to 90% by weight, from 30% to 80% by weight, from 40% to 70% by weight, from 50% to 60% by weight, based on the total amount of the curable silicone-based composition.

### Component (B)

In the present invention, component (B) may be used to adjust crosslink density and can be any silicones having an average of at least two silicon-bonded hydrogen atoms per molecule. The remaining valences of the silicon atoms are satisfied by divalent oxygen atoms or by monovalent alkyl radicals having from 1 to 6 carbon atoms per radical, such as methyl, ethyl, propyl, isopropyl, butyl, and hexyl and phenyl groups. The organohydrogensilicones can be homopolymers, copolymers, and mixtures thereof. Preferably, the organohydrogensilicones comprises, but not limited to, a copolymer of trimethylsiloxy and methylhydrogensilicones or a copolymer of trimethylsiloxy, methylhydrogensilicones and dimethylsilicones. In an embodiment of the present invention, the organohydrogensilocones have an average of at least three silicon-bonded hydrogen atoms per molecule. In an embodiment of the present invention, the viscosity of component (B) is from 1 cst to 500 cst, from 2 cst to 300 cst, from 5 cst to 100 cst, from 10 cst to 80 cst, from 10 cst to 60 cst, from 10 cst to 40 cst or from 10 cst to 20 cst at 25° C. In an embodiment of the present invention, component (B) comprises 0.01-1.67 wt %, 0.02-1.5 wt %, 0.05-1.3 wt %, 0.1-1.1 wt %, 0.2-1.0 wt %, 0.4-0.8 wt % or 0.5-0.6 wt % SiH. In an embodiment of the present invention, component (B) is hydrogenated silicone oil having a viscosity 20 cst at 25° C. and about 1.6 wt % SiH.

With particular preference, component (B) may be incorporated into the curable silicone-based composition in an amount of from 4% to 20% by weight, from 6% to 16% by weight or from 8% to 14% by weight, such as 12% by weight, based on the total amount of the curable silicone-based composition.

In some embodiments of the present invention, component (B) can has an amount of 0.2-20 parts by weight, 0.5-18 parts by weight, 1-16 parts by weight, 2-14 parts by weight, 5-10 parts by weight, 7-9 parts by weight, based on 100 parts by weight of component (A).

### Component (C)

In the present invention, component (C) can be selected from the group consisting of platinum, palladium, rhodium, nickel, iridium, ruthenium catalysts and mixtures thereof, preferably platinum catalyst, which can efficiently promote the reaction of —SiH groups with vinyl groups. Particularly preferred is a two-component curable silicone composition wherein the catalyst is an organoplatinum compound. Particularly preferred is a two-component curable silicone composition wherein the catalyst is functional organoplatinum compound selected from an (η-diolefin) (α-aryl) platinum complex, an (η-diolefin) (γ-aryl)-platinum complex, an (η-diolefin) (γ-alkyl)-platinum complex, and mixtures thereof. It is possible to use commercially available products in the present invention.

With particular preference, component (C) may be incorporated into the curable silicone-based composition in an amount of from 0.1% to 2% by weight, from 0.5% to 1.5% by weight or from 0.8% to 1.3% by weight, such as 1.2% by weight, based on the total amount of the curable silicone-based composition.

In some embodiments of the present invention, component (C) can has an amount of 0.1-2 parts by weight, 0.5-1.5 parts by weight, 0.8-1.3 parts by weight, 0.9-1.1 parts by weight, based on 100 parts by weight of component (A).

### Component (D)

In the present invention, component (D) can further improve flame retardancy. Generally, there is present from 2 to 250 percent by weight, from 5 to 200 percent by weight, from 10 to 150 percent by weight, from 15 to 120 percent by weight, from 15 to 100 percent by weight, from 20 to 80 percent by weight or from 30 to 50 percent by weight of flame retardant additives, based on 100 parts by weight of component (A), which depends on flame retardant requirement of the polysiloxane composite. The flame retardant additive may comprises non-flammable fibers and sulfur-free carbon black. The non-flammable fibers are thought to aid in retaining the char formed when the composite is subjected to flame, to protect the composite under the charred surface. The nonflammable fibers can be selected from such fibers as carbon fibers, ceramic fibers, and aramide fibers, with ceramic fibers being preferred. The fibers should be fine fibers with average diameters of less than 5 micrometres and lengths of less than 100 millimetres so that the fibers can be evenly and easily distributed throughout the mixture. Preferably, there is present from 1 to 5 percent by weight of the non-flammable fibers and 1 to 5 percent by weight of sulfur-free carbon black. The carbon black added can be any of the usual sulfur-free carbon blacks used as additives in silicone elastomers cured with a platinum catalyst. The carbon black is sulfur-free because sulfur might interfere with the cure.

In some embodiments of the present disclosure, the flame retardant additive comprises, but not limited to, halogenated flame retardant additive and/or non-halogenated flame retardant additive, in which examples of the halogenated flame retardant additive comprise brominated flame retardant additive such as brominated polymer or oligomers, brominate styrene-butadiene-styrene copolymer, and preferably combinations of the brominated flame retardant additives with antimony trioxide for forming Br—Sb synergetic system; and examples of the non-halogenated flame retardant additive may comprise of but not limited to, aluminum hydroxide, magnesium hydroxide, hydromagnesite, ammonium polyphosphate, melamine polyphosphate, piperazine polyphosphate, expandable graphite and mixtures thereof. In the present invention, the flame retardant additives may be dispersed in or distributed throughout the silicone-based polymeric binder (i.e., a polymer matrix) with a loading in the range of 1~ 70 mass % of the dried material. The flame retardant additives with a loading >70 mass % may result to insufficient mechanical performance required in Battery fire protection application.

### Component (E)

In the present invention, component (E) is introduced into the silicone-based matrix under a condition of mixing or, preferably, mixing and shearing, mixing and agitating or a combination of mixing, shearing and agitating, so as to give a water-in-oil emusion, in which the water droplets have an average droplet size of ≤100 μm, ≤80 μm, ≤50 μm, ≤30 μm, ≤10 μm or ≤5 μm. Preferably, the average droplet size is greater than or equal to 100 nm, 300 nm, 500 nm, 800 nm or 1 μm.

In accordance with the present invention, the mixing, shearing and/or agitating may be carried out by any conventional means for forming a mortar or simple mixing. For example, component (E) may be mixed by hand or with a low shear mixer, such as a cement mixer, a static mixer or a medium or high shear mixer, such as a homogenizer or other conventional foam mixing device.

Differentiated from the prior arts in which water is used as a chemical foaming agent in a relatively small amount, e.g., 0.1% to 5% by weight based on the total amount of the curable silicone-based composition, component (E) in the present invention has much greater amount based on the total amount of the siicone-based matrix. In some embodiments of the present invention, the amount of component (E) is 5~1000 parts by weight, 10~800 parts by weight, 10~500 parts by weight, 10~300 parts by weight, 10~150 parts by weight, 20~130 parts by weight, 30~110 parts by weight, 40~100 parts by weight, 50~90 parts by weight, or 60-70 parts by weight, based on 100 parts by weight of component (A).

### Component (F)

To promote dispersing of the water droplets in relatively small mean cell size, applying much more amount of component (E) ino the polysiloxane composite and thereby preserve consistency and homogeneity of the water-in-oil emulsion, one or more thickeners may be included. The thickener is a component that thickens water of the present invention to improve consistency, homogeneity, workability and storage stability. The thickener according to the present invention includes one or more types selected from water-soluble organic polymers, clay minerals or a mixture thereof.

Examples of water-soluble organic polymers can include high-molecular polysaccharides, water-soluble acrylic resins, and the like. In particular, the use of a water-soluble organic polymer containing a carboxylate group is preferred, and preferred examples include polyacrylates, which are carboxyl-containing attached polymers, such as sodium polyacrylates, sodium polymethacrylates, and the like.

The clay mineral may be natural or synthetic, and examples include natural or synthetic smectite clay such as bentonite, montmorillonite, hectorite, saponite, soconite, bidelite, nontronite, and the like; and aluminum silicate magnesium are exemplified. Smectite clay such as bentonite, montmorillonite, and the like are preferred. Such smectite clays are available, for example, as SUMECTON SA (manufactured by Kunimine Industries Co., Ltd.), which is a hydrothermally synthesized product, and BEN-GEL (manufactured by HOJUN., Co. Ltd.), which is a naturally refined product. Note that these clay minerals may be synthetic smectite clays, and the synthetic smectite clays generally have a smaller particle size than natural smectite clays. For example, the average particle size is only 5 or 10% of the average particle size of natural smectite. Synthetic smectite clays have such small particle sizes, and therefore can be added in a smaller amount than natural smectite clays to produce a highly viscous aqueous gel composition. The pH of these clay minerals such as smectite clay and the like is preferably within a pH range of 5.0 to 9.0.

The water-soluble organic polymer is a component which can be modified by mixing with the clay mineral, and forms a hydrophilic composite with the clay mineral. Note that in the present invention, only one type selected from the water-soluble organic polymers or the clay minerals may be used, but both may be and are preferably used in a mixture.

The clay mineral, such as a bentonite or montmorillonite, may be modified by premixing with the water-soluble organic polymer. For example, the clay mineral and water-soluble organic polymer may be uniformly mixed in water, and the mixture may then be dried, for example by spray drying. The resulting dry mixture may be ground, if necessary, to a desired particle size, which may be within a range of 1 to 20 μm. The amount of water-soluble polymers in such a mixture may range, for example, from 0.1 wt % to 40 wt %.

Examplary thickeners of the present invention includes, but not limited to, nanoclay, cellulose, polyacrylate, a hydrophobically modified anionic thickener, a hydrophobically modified alkali swellable emulsion (HASE), for example, hydrophobically modified acrylic acid copolymers such as ACRYSOL TM TT935 (Dow). A hydrophobically modified acrylic acid copolymer comprises two or more hydrophobic groups, such as an aryl or phenyl group, or a C 4 or higher alkyl group.

The total amount of the one or more thickeners may range from 0.2 to 5 parts by weight, 0.5 to 5 parts by weight, from 1 to 4 parts by weight, from 2 to 3 parts by weight, based on 100 parts by weight of component (E). If the amount of the thickener exceeds the upper limit described above, the viscosity of thickened water (M) may become excessively high, and the workability may deteriorate.

In some embodiments of the present invention, the thickeners are firstly added into component (E) to provide a thickened water (M). The thickening performance of the thickener is not particularly limited, but from the perspective of a technical effect of the present invention, thickening properties are preferably provided, where thickened water (M) has a viscosity in the range of 5,000~1,000,000 cst, 20,000~800,000 cst, 50,000~500,000 cst, 100,000~300,000 cst or 150,000~250,000 cst at 25° C. and 0.1s−1; and a viscosity in the range of 1,000~10,000 cst, 3,000~9,000 cst, 5,000~8,000 cst or 6,000~7,000 cst at 25° C. and 10s−1.

### Component (G)

In the present invention, the curable silicone-based composition can be in the form of an water-in-oil emulsion. For good dispersity, the curable silicone-based composition can further includes at least one component (G), i.e., emulsifier. In preferred embodiments, the emulsifier is nonionic emulsifier. In more preferred embodiments, said emulsifier can be selected from the group consisting of polysiloxane polyether, alkyl-poly(ethylene oxide), polyoxyethylene-polyoxypropylene copolymer and mixtures thereof.

For example, the polyoxyethylene-polyoxypropylene copolymer nonionic emulsifier is usually a compound expressed by the following general formula (1) or general formula (2).

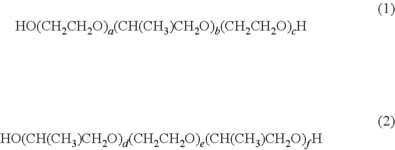

In general formulae (1) and (2), a, b, c, d, e and f are the average number of mols of ethylene oxide or propylene oxide added, and are each independently a number between 1 and 350. The weight average molecular weight of the polyoxyethylene-polyoxypropylene copolymer is preferably 1,000 to 18,000, and more preferably 1,500 to 10,000. Component (G) can be used in an aqueous solution, if in a solid form.

More specific examples of compounds serving as component (G) include the Pluronic (registered trademark) L series, Pluronic (registered trademark) P series, Pluronic (registered trademark) F series, and Pluronic (registered trademark) TR series manufactured by ADEKA CORPORATION; Emulgen PP-290 manufactured by Kao Corporation; and Newcol 3240 manufactured by Nippon Nyukazai Co., Ltd., which are available on the market.

In some embodiments of the present invention, the emulsifier (G) is free of any ionic emulsifier. In general, an anionic surfactant, cationic surfactant and/or amphoteric surfactant can be used as an ionic emulsifier. So in the present invention, the curable silicone-based composition can be substantially free of any surfactants. Examples of anionic surfactants include alkylbenzene sulfonate, alkyl ether sulfate, polyoxyethylene alkyl ether sulfate, polyoxyethylene alkyl phenyl ether sulfate, alkyl naphthyl sulfonate, unsaturated aliphatic sulfonate, and hydroxylated aliphatic sulfonate. Examples of cationic surfactants include quaternary ammonium type salt surfactants, such as: octadecyl trimethyl ammonium chloride, hexadecyl trimethyl ammonium chloride, and other alkyl trimethyl ammonium salts; dioctadecyldimethyl ammonium chloride, dihexadecyldimethyl ammonium chloride, didecyldimethyl ammonium chloride, and other dialkyldimethyl ammonium salts; and the like. Examples of amphoteric surfactants include alkylbetaines and alkylimidazolines.

In the present invention, the emulsifiers can be firstly added into silicone oil composite mixture (N). In some embodiments of the present invention, the amount of component (G) can be within a range of 0.2 to 5 parts by weight, 0.5 to 5 parts by weight, 1 to 4 parts by weight, 2 to 3 parts by weight, based on 100 parts by weight of component (A). If the amount of the emulsifier exceeds the upper limit described above, it deteriorates the mechanical strength of final polysiloxane composite.

### Component (H)

In the present invention, the hydrosilylation catalyst inhibitor is an optional component, which can slow the reaction rate by inhibiting the hydrosilylation catalyst as needed so that mixing can be completed before the mixture starts curing reaction.

Therefore, it shall be understood that in case curing cannot be conducted quickly during and right after mixing, it may become necessary to add component (H), but in case curing can be conducted immediately right after mixing, it may not need to add component (H). Determining whether it needs to add component (H) into the polysiloxane composite is within the capability of one of ordinary skill in the art.

Examples of the hydrosilylation catalyst inhibitor comprise methylvinylcyclosiloxane, tetravinyltetramethyl-cyclotetrasiloxane (vinyl D4), ethynylcyclohexanol (ECH) and mixtures thereof. With particular preference, the hydrosilylation catalyst inhibitor may be incorporated into the curable silicone-based composition in an amount of from 0% to 2% by weight, from 0.05% to 1.5% by weight or from 0.5% to 1.2% by weight, such as 0.1% by weight, based on the total amount of the curable silicone-based composition, which depends on desired curing speed.

In some embodiments of the present invention, the amount of component (H) is 0.05~2 parts by weight, 0.1~1.5 parts by weight, 0.5~1.0 parts by weight or 0.7~0.9 parts by weight, based on 100 parts by weight of component (A).

### Component (I)

In the present invention, component (I) is one or more opacifiers which can absorb, scatter and reflect thermal radiation. The particle size of these opacifiers can be in the range 0.2-50 μm, 0.5-20 μm, 1-10 μm or 2-5 μm. Examples of the opacifiers are titanium oxides, zirconium oxides, ilmenites, iron titanates, iron oxides, zirconium silicates, silicon carbide, manganese oxides and carbon black or any combination thereof. In one embodiment, carbon black or Fe₃O₄ can be utilised as the opacifier. Component (I) is typically present in an amount of from 0.2 to 20 wt %, alternatively from 1 to 15 wt %, alternatively 2 to 12 wt %, based on the total amount of the curable silicone-based composition. Component (I) is available commercially.

### Process for Producing the Battery Pack

In the present invention the battery pack can be made by curing, e.g., emulsion curing, the curable silicone-based composition which partially or fully filling the gap between two adjacent cells. The cured polysiloxane composite has cells with mean cell size of ≤100 μm. The components of the curable silicone-based composition before curing are as above described.

In the present invention, the process for producing the battery pack comprises following steps:
Step (I): providing a mixture comprising components (A), (B), (C) and (D);
Step (II): applying component (E) into the mixture under a mixing and shearing condition, so as to provide a water-in-oil emulsion comprising water droplets with average droplet size≤100 μm;
Step (III): heating the water-in-oil emulsion to cure the polysiloxane matrix and form cured wet composite; and
Step (IV), assembling the cured composite between cells in battery pack.

In some embodiments, before applying component (E), component (F), i.e., thickener, can be optionally added into component (E), which allows for enough shearing and time to reach fully thickening effect. In Step (II), thickened component (E) can be applied into the mixture obtianed in Step (I)

In step (I), component (A) can be mixed with other components except components (E) and (F) to give a silicone based mixture (N). Then, component (E) or thickened component (E) (i.e., thickened water (M)) can be added into mixture (N). By applying enough shearing and time, water droplets can be dispered in the silicone based mixture, with average droplet size of ≤100 μm, ≤80 μm, ≤50 μm, ≤30 μm, ≤10 μm or ≤5 μm. Preferably, the average droplet size is greater than or equal to 100 nm, 300 nm, 500 nm, 800 nm or 1 μm. Optionally, any other components can be added into the mixture at this time under a mixing condition. By introducing water, the silicone based mixture forms a water-in-oil emulsion.

The water-in-oil emulsion can be heated at a temperature ranging from 60° C. to 200° C. for a period of time, for example, 5 min. to 24 hours. In the present invention, the temperature and time are not particularly limited, as long as they are enough to conduct curing of water-in-oil emulsion through the reaction between alkylene group and Si—H group. By curing, the water-in-oil emulsion forms a cured wet composite with water droplet dispersed therein. Any techniques for avoiding significant water evaporation, e.g., high pressure and/or sealed reactor, can be used during the curing.

When the curing is complete, water can be removed partially or fully from the cured wet composite by raising the temperature above boiling point of water at the operation condition, allowing enough time to remove water partially or fully from the cured wet emulsion. A partially or fully dried polysiloxane composite having mean cell size≤100 μm can be obtained.

In the present invention, the battery pack or polysilxane composite is prepared only by means of component (E), without intentionally adding or using any physical or chemical foaming agents.

Further, since the dried polysiloxane composite of the present invention is prepared by means of emulsifying, curing, and drying process rather than chemical foaming process, its manufacturing process will have process benefit of operator-friendly without generating odor and operation safety without generation of hydrogen gas.

### EXAMPLES

The following is a more detailed description of the present invention with reference to examples. The present invention, however, is not restricted to these examples. All parts and percentages are by weight unless otherwise specified.

### [Tensile Strength]

The tensile strength of the polysiloxane composite was measured according to CTM 0137A.

### [Density]

The density of the polysiloxane composite was measured according to ASTM D792.

### [Thermal Insulation Test]

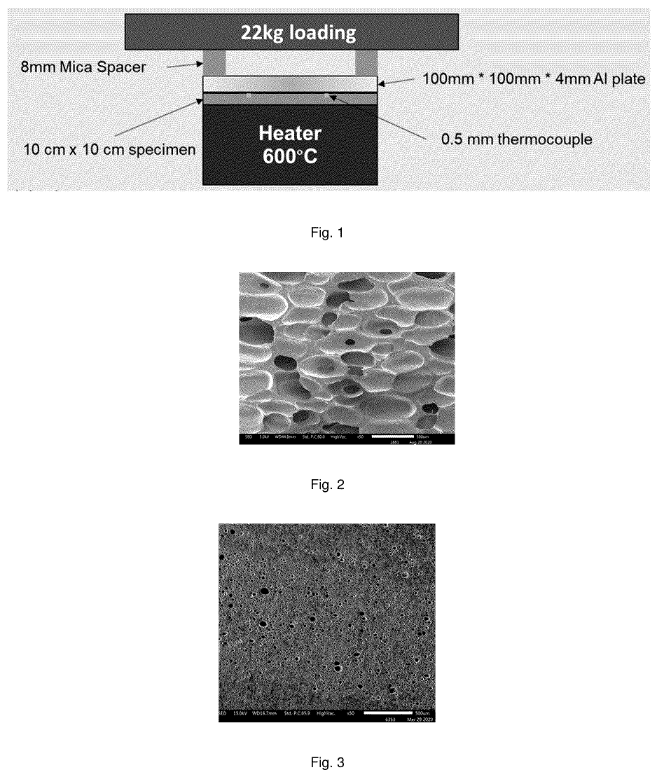

FIG. 1 illustrated the experimental set up of thermal insulation performance test. A 10 cm×10 cm×0.35 cm sample was placed on a heater at 600° C. Two thermo-couples were placed on the backside of sample to monitor the temperature. An aluminum plate was put on the top of sample to mimic adjacent battery cells in a battery module. On the top of the aluminum plate, some loadings were added to mimic the pressure during thermal runaway process.

### [Mean Cell Size]

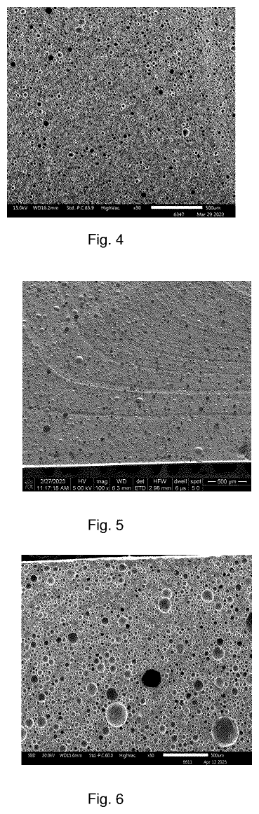

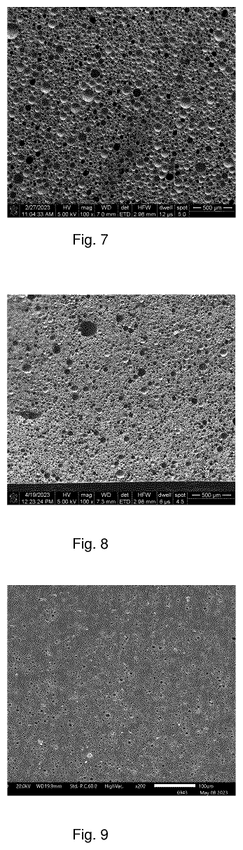

Deep learning-based segmentation method was adopted to segment the silicone foam or composite SEM images. FIG. 2-9 show SEM images of CE1-2 and IE1-6 according to the present invention. This technique can precisely segment pores from a diverse range of image formats without requiring model retraining or parameter adjustments. The neural network utilized in this process is based on the U-Net architecture, and the model has been trained on a dataset of over 70,000 segmented objects from highly varied microscopy images. The resulting model can generate a mask that features multiple labeled image regions. The scikit-image toolkit is utilized to analyze the mask and generate properties of the labeled image regions. The toolbox is built using python 3.8 and relies on dependencies such as pytorch, numpy, scipy, and scikit-image. Details are also described in website “https://arxiv.org/abs/1505.04597v1” with a name of “U-Net: Convolutional Networks for Biomedical Image Segmentation”.

The information of the raw materials used in Examples is listed in the following Table 1:

TABLE 1
Raw materials used in Examples

| Ingredient Type | Chemical Description, Chemical formula, or Structure |
|---|---|
| Polymer | Vinyl-terminated PDMS, viscosity 60000 cst, |
| | vinyl content: 0.09 wt % |
| Filler | Hydromagnesite, d₅₀ 4 μm |
| Resin | Blend of PDMS and resin, 35% resin, viscosity |
| | 5000 cst, vinyl content: 0.88 wt % |
| Pigment | Blend of PDMS and carbon black, 50% carbon black |
| Catalyst | Platinum catalyst |
| Inhibitor | Cyclic methyl-vinyl siloxane, D4 |
| Blowing agent | Benzyl alcohol |
| Crosslinker 1 | Copolymer of methyl-hydro siloxane and dimethyl |
| | siloxane, Si—H content: 0.69 wt % |
| Crosslinker 2 | Polymethylhydrosiloxane, Si—H content: 1.61 wt % |
| Thickener | Sodium bentonite |
| Emulsifier 1 | Silicone polyether, HLB = 2. |
| Emulsifier 2 | Silicone polyether, HLB = 12.2. |

### Inventive Examples 1-6 (IE 1~6) and Comparative Examples 1-2 (CE 1-2)

In Inventive Examples 1-6 of the present disclosure, the polysiloxane composites were produced using those raw materials and their amounts described in Table 2. Comparative Examples 1-2 were provided here as control.

TABLE 2
Formulations used in Inventive Examples and Comparative Examples

| | | | | | | | | |
|---|---|---|---|---|---|---|---|---|
| Ingredient | | | | | | | | |
| Type | CE1 | CE2 | IE1 | IE2 | IE3 | IE4 | IE5 | IE6 |

Part A:

| | | | | | | | | |
|---|---|---|---|---|---|---|---|---|
| Resin | 28 | 92.5 | 85.0 | 81.5 | 81.5 | 81.5 | 81.5 | 81.5 |
| Polymer | 21 | 7.5 | | 7.5 | 7.5 | 7.5 | 7.5 | 7.5 |
| Filler | 42 | | 15 | 7.5 | 7.5 | 7.5 | 7.5 | 7.5 |
| Pigment | 7.2 | | | 3.5 | 3.5 | 3.5 | 3.5 | 3.5 |
| Inhibitor | | 0.1 | 0.1 | 0.1 | 0.1 | 0.1 | 0.1 | 0.1 |
| Catalyst | 0.4 | 0.1 | 0.1 | 0.1 | 0.1 | 0.1 | 0.1 | 0.1 |
| Blowing | 1.4 | | | | | | | |
| Agent | | | | | | | | |
| Emulsifier 1 | | | | | | | 0.6 | |
| Emulsifier 2 | | | | | | | 1.4 | |

Part B:

| | | | | | | | | |
|---|---|---|---|---|---|---|---|---|
| Polymer | 8 | | | | | | | |
| Resin | 3.5 | | | | | | | |
| Crosslinker 2 | 3 | | | | | | | |
| Crosslinker 1 | 2 | 5 | 5 | 5 | 5 | 5 | 5 | 5 |

Part C:

| | | | | | | | |
|---|---|---|---|---|---|---|---|
| Water | 50 | 50 | 50 | 100 | 150 | 150 | 30 |
| Thickener | 0.75 | 0.75 | 0.75 | 1.50 | 2.25 | 2.25 | |

Silicone base composition/formulation preparation:

Part A: All ingredients listed in Part A of Table 2 were mixed in SpeedMixer at 1500 rpm for 2 min with vacuum.

Part B: All ingredients listed in Part B of Table 2 were mixed in SpeedMixer at 1500 rpm for 2 min with vacuum.

Part C: All ingredients listed in Part C of Table 2 were mixed with agitator at 1500 rpm for 10 min.

Polysiloxane composite fabrication:

1. In CE1 using H2-blowing foam

Part A and B were mixed using Speedmixer at 1500 rpm for 30s. Then the mixture was casted into a sheet with desired thickness between two PET films. The sheet was cured and foamed in an oven at 70° C. for 10 min. The foamed silicone sheet was delaminated from PET films and post-cured in an oven at 170° C. for 30 min. After post-curation, the properties and performances of silicone foam sheet were measured.

2. In CE2 and IE1~6 using a water-in-oil emulsion

Part A and B were mixed using Speedmixer at 1500 rpm for 30s. Part C was hand-mixed into the mixture and then Speed-mixed at 1500 rpm for 30s with vacuum. The mixture was then casted into a sheet with desired thickness between two PET films. The sheet was cured in an oven at 80° C. for 10 min. The cured silicone sheet was delaminated from PET films and put into an oven at 180° C. for 60 min to remove water. After water was removed, the properties and performances of the silicone composite were measured.

TABLE 3
Summary of properties of Examples

| | CE1 | CE2 | IE1 | IE2 | IE3 | IE4 | IE5 | IE6 |
|---|---|---|---|---|---|---|---|---|
| Density (g/cm³) | 0.50 | 0.74 | 0.76 | 0.74 | 0.54 | 0.41 | 0.43 | 0.84 |
| Mean Cell Size (μm) | 300 | 14 | 8 | 8 | 24 | 55 | 23 | 4 |
| Tensile strength (MPa) | 0.41 | 3.06 | 4.94 | 3.14 | 3.49 | 3.80 | 1.06 | 3.2 |
| Elongation (%) | 124 | 56.2 | 54.4 | 79.5 | 57.8 | 61.8 | 56.3 | 63.1 |
| Thermal insulation | 326 | Burnt | 268 | 251 | 264 | 287 | 268 | 274 |
| (Back temperature) | | | | | | | | |
| at 600 °C | | | | | | | | |

As shown in Table 3, CE1 was a traditional H2-blowing silicone foam with a mean cell size of 300 μm. It exhibited higher thermal conductivity and worse thermal insulation performance as measured at 600° C. In IE1~6, they all exhibited much small mean cell size. CE2 was a micro-cell silicone composite without flame retardant filler, which exhibited poor thermal insulation performance.

In IE1~6, they all exhibited lower thermal conductivity and better thermal insulation performance. Meanwhile, due to micro-cell structure, its tensile strength and elongdation is much better than those in CE1.

1. A battery pack comprising a polysiloxane composite, wherein the polysiloxane composite partially or fully fills a gap between two adjacent battery cells, and has a mean cell size≤100 μm.

2. The battery pack according to claim 1, wherein the polysiloxane composite has a close cell percentage of ≥50%.

3. The battery pack according to claim 1, wherein the polysiloxane composite is obtained by curing a curable silicone-based composition comprising:
(A) at least one organopolysiloxane having at least two alkenyl groups bonded to silicon per molecule;
(B) at least one organopolysiloxane having at least two hydrogen atoms bonded to silicon per molecule;
(C) a hydrosilylation catalyst;
(D) at least one flame retardant filler; and
(E) water.

4. The battery pack according to claim 3, wherein:
i) component (B) is present in the curable silicone-based composition in an amount of from 0.5 to 20 parts by weight, based on 100 parts by weight of component (A); and/or
ii) component (D) is present in the curable silicone-based composition in an amount of from 2 to 250 2-250-parts by weight, based on 100 parts by weight of component (A); or
iii) both i) and ii).

5. The battery pack according to claim 3, wherein component (E) is present in the curable silicone-based composition in an amount of from 5 to 1000 parts by weight, based on 100 parts by weight of component (A).

6. The battery pack according to claim 3, wherein the curable silicone-based composition further comprises:
(F) at least one thickener present in an amount of from 0.2 to 5-parts by weight, based on 100 parts by weight of component (E).

7. The battery pack according to claim 6, wherein component (F) is selected from the group consisting of nanoclay, cellulose, polyacrylate and mixtures thereof.

8. A process for producing the battery pack according to claim 3, the process comprising the following steps:
(I): providing a mixture comprising components (A), (B), (C) and (D);
(II): applying component (E) into the mixture under a mixing and shearing condition, so as to provide a water-in-oil emulsion comprising water droplets with average droplet size≤100 μm;
(III): heating the water-in-oil emulsion to cure the polysiloxane matrix and form a cured wet composite; and
(IV): assembling the cured wet composite between cells in the battery pack.

9. The process for producing the battery pack according to claim 8, wherein the process further comprises the following step:
applying (F) at least one thickener into component (E) under a mixing and shearing condition, so as to provide a thickened component (E) before step (II).

10. The process for producing the battery pack according to claim 8,
wherein the process further comprises the following step:
(V) partially or fully removing water from the wet composite formed in step (III).

11. The battery pack according to claim 4, wherein proviso i) is true.

12. The battery pack according to claim 4, wherein proviso ii) is true.
